(19) United States
(12) Patent Application Publication
(10) Pub. No.: US 2024/0173905 A1
(43) Pub. Date: May 30, 2024

(54) METHOD FOR AVOIDING PARALLELISM OF LOAD PEAKS OF A PLASTIC-PROCESSING MACHINE, MORE PARTICULARLY AN INJECTION MOLDING MACHINE OR SHAPING MACHINE, AND PLASTIC-PROCESSING SYSTEM

(71) Applicant: Wittmann Technology GmbH, Wien (AT)

(72) Inventor: Michael Peter WITTMANN, Leobendorf (AT)

(73) Assignee: Wittmann Technology GmbH, Wien (AT)

(21) Appl. No.: 18/285,072

(22) PCT Filed: Mar. 12, 2022
(86) PCT No.: PCT/AT2022/060074

§ 371 Date: Sep. 29, 2023

(30) Foreign Application Priority Data
Apr. 2, 2021 (AT) A50236/2021

(51) Int. Cl. B29C 45/76

(52) U.S. Cl. CPC B29C 45/7666; B29C 45/762; B29C 2945/7603; B29C 2945/76521

(57) ABSTRACT

A plastics processing plant and method for avoiding parallel occurrence of load peaks of a plastics processing machine, in particular an injection-molding machine and at least one production resource. The injection-molding machine, which includes a temperature control unit, hot runner system, cooling unit, flow controller, granule dryer, mold dryer, metering device, robot, and automation system, is connected via an electrical line or data line to the at least one production resource directly or indirectly via an external work cell controller. The injection-molding machine or the external work cell controller transmits one or several control signals or internal operating states with increased load requirement, to the production resource so that the production resource performs a load shift, load reduction or load shedding at the times of the increased load requirement of the injection-molding machine.

The present invention relates to a method for avoiding parallel occurrence of load peaks of a plastics processing machine, in particular an injection-molding machine or a forming machine, as well as of a plastics processing plant, as described in claims 1 to 10.

The essential current operating expenses for production resources for plastics technology, in particular injection-molding machine and peripheral devices for temperature control, heating, drying and/or cooling of mold, injection molding machine and/or material to be processed and thus for the production of injection-molded parts include electricity costs. As a rule, a time interval of 15 minutes is used by the energy suppliers as the assessment basis for the purchased power consumption. However, power price-based electricity contracts incur not only costs for the real energy purchased. Additionally, the highest monthly or annual peak power demand is also determined and billed. This portion of the power price can amount to up to 30 percent of the total cost of electricity. Electricity costs can thus be reduced not only by reducing electricity consumption but also by lowering transient power peaks.

Since the injection molding process by design represents a discontinuous production process with various phases, it is not possible to achieve a cost-optimized, and therefore constant, load consumption.

Commercially available solutions address load management during the start-up of production resources, wherein the load management system has specifications that are typically based on business criteria and the knowledge and priority of production orders.

Hence, this type of holistic peak load management needs to be coupled to an ERP (Enterprise Resource Planning) system or MES (Manufacturing Execution System).

DE 10 2012 111 046 A1 pursues a different approach. It describes a method for limiting the maximum power consumption of a production machine, in particular an injection-molding machine. An injection-molding machine typically consists of a large number of power consumers, referred to as aggregates or aggregate groups in the method according to the present invention, which, depending on their functionality, can be operated at times with reduced power consumption without entailing a loss of quality of the product to be manufactured. The method is particularly advantageous during the start-up (heating up of the individual aggregates/aggregate groups) of an injection-molding machine, e.g. after a weekend, since the reduced power consumption of aggregates/aggregate groups to limit the instantaneous total power consumption is noticeable as a longer heating-up phase, but has no effect on product quality. The method can also be used during regular operation of the injection-molding machine, i.e. during operation for the production of parts, especially for limiting existing heating elements on the machine (cylinder heating).

A disadvantage, however, is that only the components of the injection-molding machine are taken into account in terms of power consumption, and the other peripheral devices that are necessary for operation of the injection molding machine are not considered in any way. This can often lead to overlapping in terms of energy consumption, especially in the areas where the injection-molding machine has the greatest power consumption.

Furthermore, DE 10 2012 104 493 A1 discloses a superordinate machine-independent energy management system (“master system”), which serves to coordinate the electrical power consumption of several production machines. In this case, too, the master system is connected to several production machines and intervenes at least in a controlling and if necessary also in a regulating manner in the power consumption for supplying energy to each of the individual production machines. The aforesaid document refers to machines processing plastic material, not to the necessary peripheral and auxiliary equipment, which is operated independently and autonomously from the production machine.

Furthermore, a method for operating a group of injection-molding machines is known from AT 12 820 U1, in which the energy or power demand of each injection molding machine belonging to a group is monitored by a group controller. Here, the group controller continuously calculates the total energy or power demand of the group and, whenever a predefined limit value is reached or exceeded, an energy or power limit or shift to any injection-molding machine belonging to the group, respectively, can be performed in order to prevent or stop a predefined peak value being exceeded, respectively. A disadvantage of this method is the temporary extension of cycle times of individual injection molding machines in the group, since machine cycles typically differ, and a cycle shift of an injection-molding machine must therefore be applied repeatedly. A shift is tantamount to a cycle extension, which on the one hand reduces the efficiency of an injection-molding machine, and on the other hand results in variable cycle times for the production of the same parts and can thus have an impact on the quality of the parts.

Available solutions on the market represent far-reaching and comprehensive systems for peak load management of one machine, one work cell, several machines, several work cells, or all the production resources of a plant. Devices are known from the art that measure the power demand of production resources and communicate it to a dedicated central controller for load management, whereby load management can distinguish between load-shifting, load-reducing, load-flexible and load-expansive control measures, or be selected accordingly, respectively. Depending on the control measure, appropriate control signals are sent to the production resources participating in the load management.

The disadvantage of this method is the high investment and installation effort, since all participants, in particular production resources, must be individually connected to the load management system and furnished with additional equipment.

Such systems are effective in optimizing load peaks during the start-up of production resources, as parallel occurrence of loads can be prevented by turning on production resources earlier or later.

However, during regular production operation of the production resources such systems do not provide measurable electricity savings, since it is not possible to intervene directly in the control process of production resources.

The objective of the present invention is to provide a method for avoiding parallel occurrence of load peaks of a plastics processing machine, in particular injection-molding machine or forming machine, and other production resources involved in production, wherein the injection-molding machine or forming machine or an external work cell controller transmits control signals or operating states to these other production resources so that they perform appropriate load management for avoiding parallel occurrence of load peaks.

The objective is achieved by the invention. Further solutions according to the present invention are described in the dependent claims.

The method according to the present invention for avoiding parallel occurrence of load peaks of a plastics processing machine, in particular an injection-molding machine and at least one production resource, is characterized in that the injection-molding machine or the external work cell controller sends one or several control signals or internal operating states with increased load requirement to the production resource, so that the production resource performs a load shift, load reduction or load shedding at the times of increased load requirement of the injection molding machine.

Here it is advantageous that all production resources are taken into account for energy management, whereby these adjust their energy requirement on the basis of the specification of the injection-molding machine in order to avoid any summation. Another advantage is that load activities are controlled or regulated, respectively, by the production resources in such a way that they take place in those production phases of the injection-molding machine in which the load level is low, or at least below a fixed or automatically determined load level threshold. In particular, for example, heating elements can be preheated, reduced or switched on with delay in order to be deactivated or supplied with lower energy, respectively, during the load level exceedance phases.

Advantageous features are the optional presence and use of an external work cell controller, which forms a kind of interface between the injection-molding machine and other production resources, in particular peripheral devices, for example temperature control units, hot runner controllers, cooling units, flow controllers, granule dryers, mold dryers, metering devices, robots, automation systems, etc., i.e. a production cell. Since the composition of production cells can change depending on the plastic part to be produced, a superordinate logic in the form of an external work cell controller for the logical combination of injection-molding machine and peripheral devices is advantageous. In this case, the work cell controller provides the determination of the currently connected peripheral devices and the forwarding of any control signals and operating states. In this process, the work cell controller contacts a new peripheral device (production resource) after it has been detected and receives, among other things, the device type and possible specifications. A part of the specification could be the load requirement of the entire device or even individual components of the device.

It is advantageous to have an embodiment of the work cell controller with extended logic for load management of the peripheral devices. Here, the work cell controller takes over the basic load control of the injection-molding machine and extends it so that accumulated loads of the peripheral devices and the current load of the injection-molding machine do not exceed the load peak of the injection-molding machine at any time.

However, advantageous embodiments are also such in which the load level for activating the control signal or control signals or changing the internal operating states or operating states for transmitting or indicating the presence of a load peak in the injection-molding machine or a work cell controller is freely selectable, adjustable, or automatically determined. This enables the operator of the machines or systems to, on the one hand, actively intervene in the load management if appropriate knowledge is available, or to have this done automatically by the injection molding machine or the external work cell controller.

Advantageous embodiments are also such in which the injection-molding machine continuously determines by calculation or ascertains by measurement the load level present during one or several operating cycles, in particular the operation between two successive closing operations of the mold, and stores it for subsequent analyses, in particular for determining the switching of the control signal or control signals or the internal operating states. The captured values can be displayed in diagram form with or without averaging, to enable an operator to manually determine the switching points for “high” load requirement or at least to display them graphically. Typically, however, automatic determination of the switching points of the control signal or control signals or internal operating state or operating states is performed.

Advantageous embodiments are also such in which an external work cell controller continuously measures the load level present during one or several operating cycles of the injection-molding machine, in particular the operation between two successive closing operations of the mold, and stores it for subsequent analyses, in particular for determining the switching of the control signal or control signals or the internal operating states. The acquired values are used for the automatic determination of the switching points of the control signal or control signals or the internal operating state or operating states.

However, advantageous embodiments are also such in which the injection-molding machine or an external work cell controller can also send out or display, respectively, the control signal or control signals or internal operating states with increased load requirements in advance, so that the production resources can prepare appropriate actions for load control. Here it is advantageous that this allows the relevant production resource sufficient time to reorganize the control or regulation process, respectively, to keep control elements from being switched on and off rapidly, as well as any deviations in the control process.

Advantageous embodiments are those in which the production resources are also designed to be self-learning and are able to anticipate the occurrence of a load peak in the injection-molding machine by themselves, preferably after tracking the behavior of the control signal or control signals or the internal operating states at least once in an operating cycle of the injection-molding machine, and to perform load control automatically. Here it is advantageous that better control behavior can be achieved e.g. by switching on slowly-acting control elements, e.g. heaters, prematurely and then switching them off, but only briefly, during the period of increased load requirement on the injection-molding machine. Of course, this load sharing can only be applied optionally. Similarly, the peripheral device could perform load shifting solely to limit a higher switching frequency of the elements to be controlled.

Advantageous embodiments are such in which, with automatic determination of the switching points of the control signal or control signals or the internal operating states as a function of the load level by the injection molding machine or an external work cell controller, the cumulative waiting time of the control signal or control signals or the internal operating states for load peaks does not exceed the time of approximately 15% to 25% of a total cycle of the injection-molding machine.

For operators of injection-molding machines and peripheral devices, automatic determination of the load level is very handy, since no knowledge of the process or this specific functionality of the equipment is required. In the case of automatic determination, the presence of the control signal or control signals or internal operating state or operating states for load peaks is limited to a duration of approximately 15% to 25% of a total cycle of the injection-molding machine. This specification ensures process security of the peripheral devices, since sufficient time is available for activating the load-reducing components and deferred processes can be made up.

Advantageous embodiments are such in which the injection-molding machine reports the difference between the maximum load peak in an operating cycle and the currently calculated or measured load or another measurand that directly or indirectly indicates the currently unneeded load requirement to a work cell controller. Other physical variables that directly or indirectly indicate the injection-molding machine's currently unneeded load requirement can also be reported to an external work cell controller.

Alternatively, the difference between the maximum load peak in an operating cycle of the injection-molding machine and the currently measured load can be determined directly in an external work cell controller to determine the currently unneeded load requirement of the injection-molding machine.

The advantage of this embodiment is that an external work cell controller can thereby implement more extensive load management, which specifically enables or disables peripheral devices for load consumption. The load consumption of a peripheral device can either be specified in the device configuration or set by the operator. Optionally, it is also possible to determine the load consumption by calculation or measurement. The targeted, possibly sequential activation of peripheral devices ensures that the maximum load peak of the injection-molding machine is not exceeded by the current load of the machine, as well as the accumulated load of all peripheral devices after the load peak.

Advantageous embodiments are such in which an external work cell controller determines the difference between the maximum load peak in an operating cycle of the injection-molding machine and the currently measured load of the injection-molding machine and uses this to determine the currently unneeded load requirement of the injection-molding machine.

However, advantageous embodiments are such in which an external work cell controller transmits the control signal or control signals to the production resource at different times, depending on the load consumption of the respectively active production resource, so that the total load of the production resource does not exceed the load requirement not needed by the injection-molding machine.

Furthermore, the objective of the present invention is achieved by a plastics processing plant in which the injection-molding machine or forming machine and/or an external work cell controller is designed to carry out the method according to any of claims 1 to 10, and the further production resources involved permit the load control described. It is therefore advantageous to prevent the overlapping of load peaks of an injection-molding machine and of the production resources involved in production.

The invention is explained in more detail by means of an exemplary embodiment shown in the drawings, whereby the invention is not limited to the exemplary embodiment described but transferable to equivalent solutions.

The figures show:

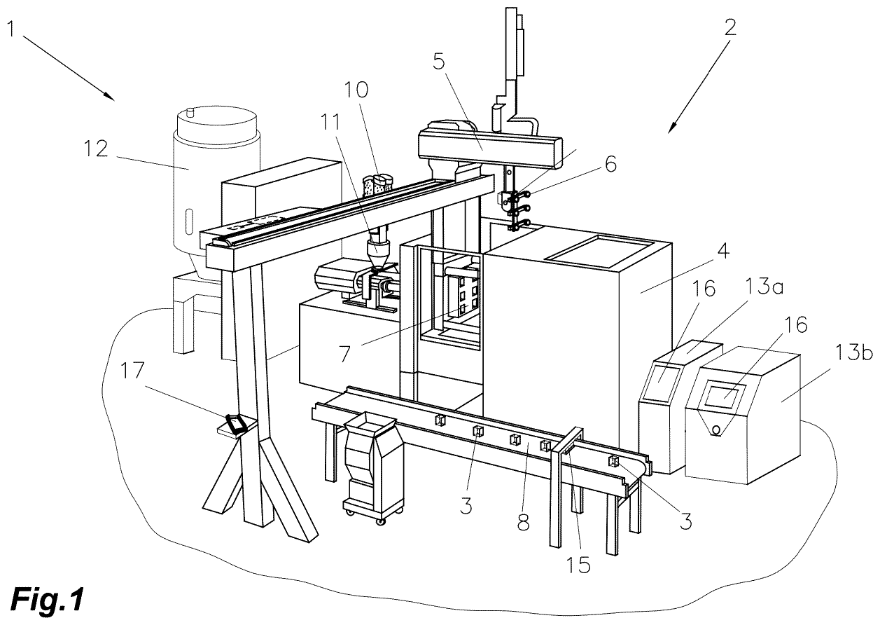

FIG. 1 an overview illustration of a plastics-processing industrial installation, simplified, for illustrative purposes only;

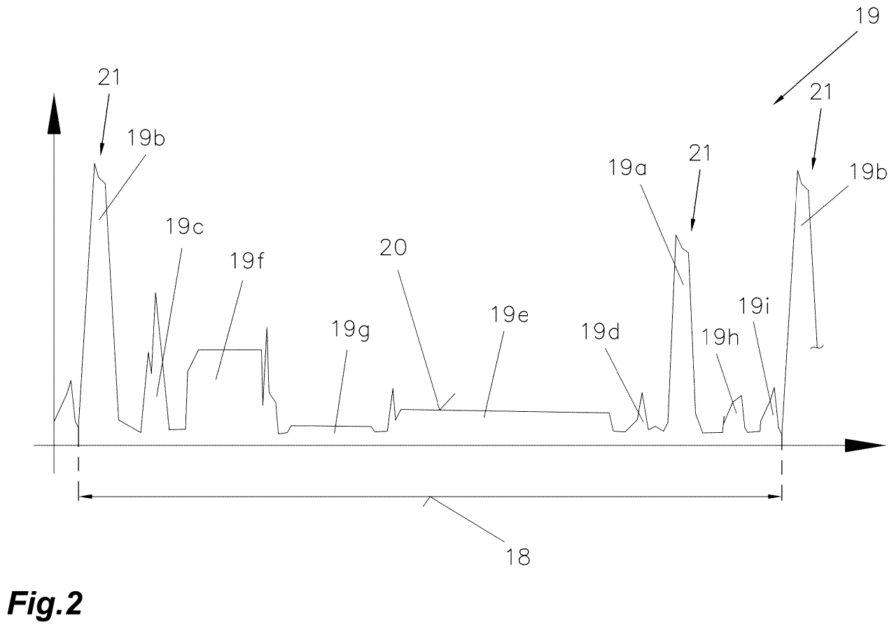

FIG. 2 a schematic representation of a total cycle of energy consumption of the primary production resources, in particular of the injection-molding machine, simplified, for illustrative purposes only

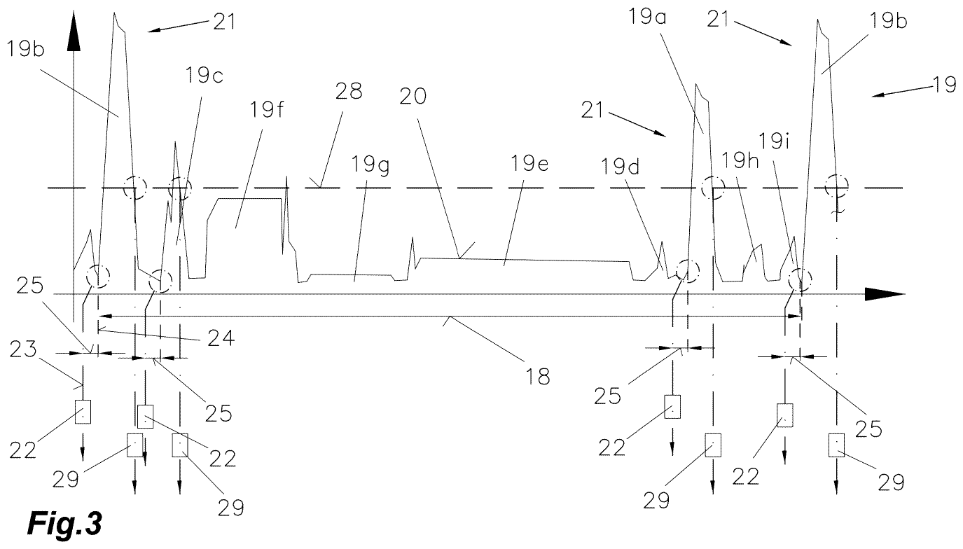

FIG. 3 a schematic representation of the total cycle according to FIG. 2 with signal times shown for transmission to the production resource, simplified, for illustrative purposes only;

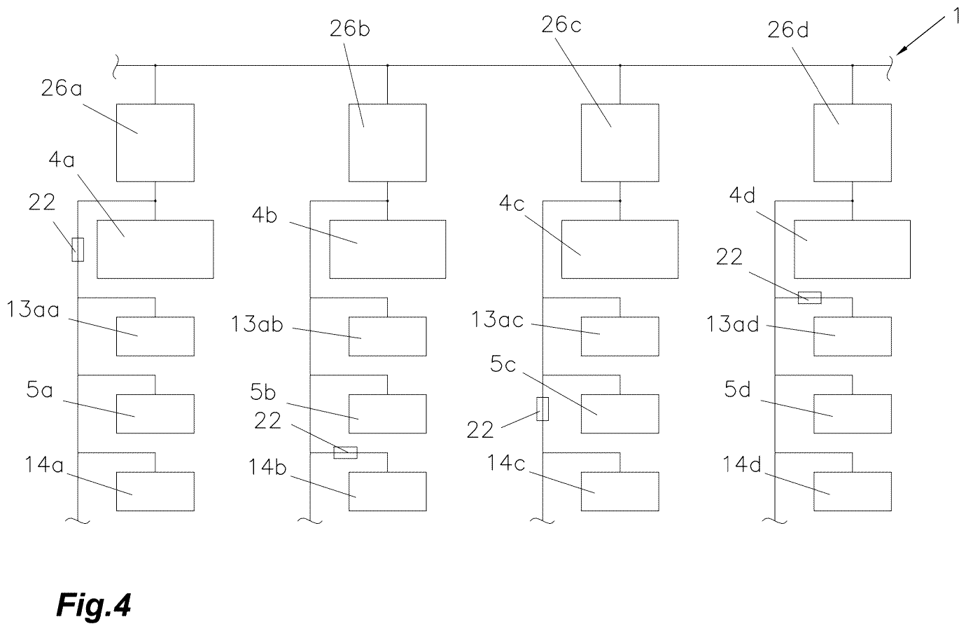

FIG. 4 a schematic representation of a plastics processing plant with superordinate work cell controllers, simplified, for illustrative purposes only;

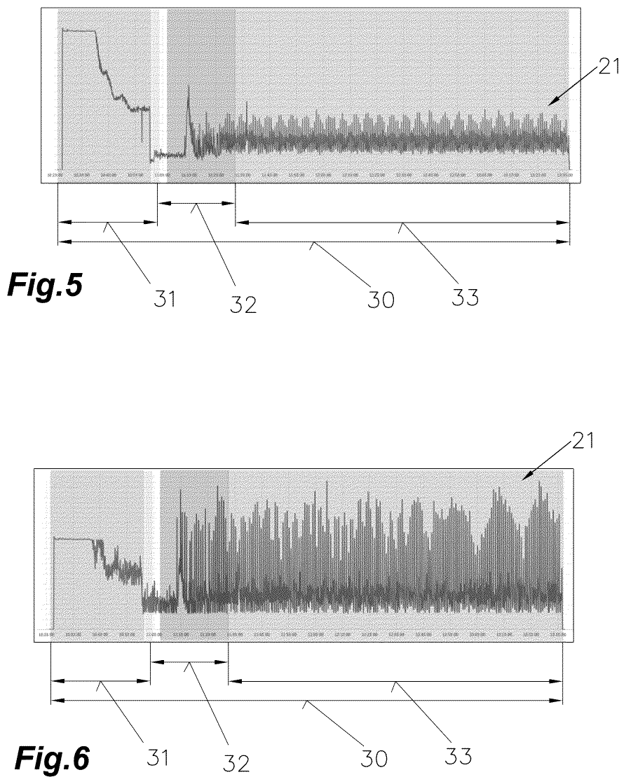

FIG. 5 an energy diagram showing the start-up, run-up and regular operation of an injection-molding machine with the average energy consumption in a respective evaluation period of 5 seconds, simplified, for illustrative purposes only;

FIG. 6 an energy diagram showing the start-up, run-up and regular operation of an injection molding machine with the maximum energy consumption in each case during a respective evaluation period of 5 seconds, simplified, for illustrative purposes only;

It should be stated by way of introduction that, in the individual embodiments, identical parts are provided with the same reference numbers or same component designations, respectively, wherein the disclosures contained in the entire description can, by analogy, be transferred to identical parts with identical reference numbers or identical component designations, respectively. The position details selected in the description, such as, e.g., top, bottom, lateral, etc., likewise relate to the figure described, and in the event of a change of position, they are to be transferred to the new position by analogy. Individual features or feature combinations from the exemplary embodiments shown and described may also represent independent inventive solutions.

FIG. 1 shows an industrial installation, in particular a work cell 1 or production cell 1, respectively, for injection molding applications, in which the individual production resources 2 or devices 2, respectively, for generating one or several products/semi-products or injection-molded parts 3 are connected in the work cell 1. The processing machine used is preferably an injection-molding machine 4, to which a robot S or handling robot, respectively, is assigned for removing the produced injection molded part 3, whereby the injection molded part 3 is removed from an opening mold 7 by a removal device 6, in particular a gripper equipped with gripper tongs or suction nozzles, and deposited on a device, for example a conveyor belt 8. In order to be able to produce an injection-molded part 3, plastic granules 9 are fed to the injection-molding machine 4 via a granules-conveying device 10 and possibly via a metering device 11. By means of a temperature control unit 13a and/or cooling unit 13b, the injection mold can be kept at operating temperature by feeding a temperature control medium or heated or cooled accordingly, respectively, so that optimum processing of the plastic granules 9, which must be plasticized for injection into the mold 7, is made possible. In addition, the plant is equipped with a monitoring device 15, in particular a camera system, in order to be able to carry out an automatic quality control of the produced product 3. In order for the individual devices to be set or programmed, respectively, they have corresponding control electronics or control logic, respectively, that are entered and displayed via displays 16 or controllers 17 arranged on the devices. For the sake of completeness, it is furthermore mentioned that all devices are connected to corresponding lines, in particular power supply, network lines, liquid supply lines, material lines, etc., which in the interest of clarity were not displayed in the representation shown.

A production cell 1 for the manufacture of injection-molded parts 3 thus consists not only of the production machine 4, but additionally of a wide variety of production resources 2, in particular peripheral devices, e.g. temperature control units 13a and/or cooling units 13b, heating channel systems, granule dryers 12, mold dryers, metering device 11, robots 5, automation systems, etc. The production resources 2 regularly use internal sensors, i.e. sensors directly integrated into the controller of the production resources 2, or external sensors, which in turn are connected to the control logic of the production resources 2 via direct wiring or a device interface. These sensors transmit analog or discrete states that subsequently trigger actuators in production resource 2 to cause the behavior necessary for the functionality of the production resource 2.

In all cases, the production resources 2 operate independently of each other in terms of load requirement and call the internal consumers according to the necessities of their own control logic and/or control logic and to fulfill the respective functionality. Furthermore, the prior art discloses production resources 2 that also run independently of each other in terms of load requirement, in particular of energy consumption, even if they should optionally be coupled on the controller side via discrete signals or data interfaces.

The primary production resource 2 of the production cell 1 for the production of injection-molded parts 3 is the injection-molding machine 4, as shown in a performance diagram in FIG. 2.

On the one hand, the injection molding machine 4 determines the total cycle 18 of production and influences the behavior of the further production resource 2 in the production cell 1 through the various production phases 19, in particular opening 19a and closing 19b of the mold, clamping force build-up 19c and clamping force reduction 19d, metering 19e with plasticizing of the material to be processed, injection 19f, cooling 19g, ejector movement forth 19h and ejector movement back 19i. For the sake of completeness, it is mentioned that such cycles, in particular overall cycles 18, may be repeated, and further processes not shown may be included in this total cycle 18.

In a constant regular operation of the injection-molding machine 4, i.e. when injection-molded parts 3 are being produced, the load consumption curve 20 approaches a relatively deterministic shape, which is, however, characterized by a small number of load peaks and relatively long periods of lower load consumption, as can be seen in FIG. 2. The load requirement, in particular the load consumption curve 20, depends very much on the machine size, equipment and the clamped mold, since, for example, injection-molding machines 4 with a smaller clamping force can have a lower load peak when moving the movable mold half than an injection-molding machine 4 with a very high clamping force and correspondingly heavier movable mold half will have. The load consumption curve 20 also depends very much on the mechanical and electrical design of the injection-molding machine 4. A phase with particularly low load consumption in each injection molding cycle is the cooling time 19g.

The other production resources 2 in a production cell 1 exhibit much more inconsistent patterns, whereby the load consumption of a single device is typically much lower than the load peak 21 of the injection molding machine 4 is. As all production resources 2 operate independently of each other in terms of load requirement, parallelism in load requirement inevitably occurs.

According to the present invention, it is envisioned here that the injection-molding machine 4 or forming machine sends an advance control signal 22, or an internal operating state 22 with increased load requirement, as schematically shown in FIG. 3, to the production resource 2, so that the at least one production resource performs a load shift, load reduction or load shedding at the times of the increased load requirement of the injection molding machine 4, i.e., that at a time 23 of the working step carried out at a later time 24 or the production phase 19, respectively, the injection-molding machine 4 transmits the control signal 22 or the information 22 to the corresponding production resource 2 or to all the production resources 2, so that these adapt their regulation or control, respectively, accordingly to the expected load requirement, in particular shift or reduce it, respectively. Depending on the subsequent production phase 19, the advance time 25 can vary, as shown schematically in FIG. 3.

This is achieved, among other things, by the fact that the energy requirement and load volume of the injection-molding machine can be predicted to a certain extent during regular operation, and this knowledge can be used by the connected production resources 2 for better load minimization or shifting. Regular operation is the state of machine 4 and production resources 2 after the respective start-up or switch-on, i.e. regularly when injection-molded parts 3 are being produced.

Here it is necessary that a data connection between the injection-molding machine 4 and at least one production resource 2, ideally as many production resources 2 as possible, which are necessary for the operation of the respective mold 7, is provided in order to transmit the corresponding information 22. As a matter of principle, however, it is also possible for an appropriately set or recorded total cycle 18 to be stored or saved, respectively, in the production resource 2 so that only a control signal 22 is sent out in advance, i.e. a period of time 25 before the production phase 19 with load peak 21 is carried out, since the production resource 2 can determine the upcoming or next production phase 19 from the stored total cycle 18. In the simplest case, the data connection is designed as a discrete signal line 22 for transmitting at least one signal from the injection-molding machine 4 to the at least one and/or the other connected production resource 2. Another embodiment provides for transmission of a plurality of discrete signals 22 e.g. associated with different operating states.

A further embodiment in the sense of Industry 4.0 provides for a much more extensive data connection. From the perspective of data processing, an example of this is the consolidation of production resources 2, including the injection-molding machine 4, to form a logical work cell 1, as envisaged in the “Wittmann 4.0” system. The “Wittmann 4.0” system and the related methods enable, for example, automatic detection and logical consolidation of the production resources 2 to form a work cell 1 via a data connection, as can be learned e.g. from WO 2019/018868 A. A plurality of work cell controllers 26 (a to d) can be arranged side by side (horizontally) and operate independently of each other, or vertically (in a tree structure consisting of multiple layers).

The injection-molding machine 4 is the primary production resource 2 in the following load analysis and control algorithm. The sequence of the individual process steps of the injection-molding machine 4 directly determines the occurrence of load peaks 21 that cannot be shifted. Each further production resource 2 can accept a more flexible load consumption to a certain extent, whereby this can be a shifting, a pre-arrangement or reduction, as this has been schematically entered in FIG. 3 for a further production resource 2 in order to be able to illustrate the invention.

Wherever the following discussion refers to the “injection-molding machine 4”, this also refers to an embodiment in which the signals 22 from the injection-molding machine are sent to a superordinate controller, e.g. work cell controller 26, and the same forwards them directly to the production resource 2 or applies its own logic for processing the signals 22 from the injection-molding machine 4 and transmitting them to the production resource 2. The logic for controlling the control signals 22 and any other information 22 (sequence, amount of peak load, etc.) is called load management. In one embodiment of the invention, the load management system transmits a control signal 22 to the production resource 2 in the presence of a load peak 21. The control signal 22 is sent out in advance, if possible, so that the production resource 2 can prepare appropriate actions for load control.

The time period for the advance signal 22 may be approximately in the range from 1 to 0.5 seconds. This time or duration 25, respectively, also serves to compensate for various delays on the transmission lines 27. The control signal 22 indicates the presence of a load peak 21 which exceeds a certain freely selectable, adjustable or automatically determined load level 28. An automatically determined load level 28 must be selected in such a way that sufficient load consumption time still remains for the other production resource 2. Of course, this level is also influenced by the number of connected production resources 2. In this respect, presence of the “Wittmann 4.0” system is advantageous, since in this case connected production resource 2 are known to the work cell controller 26 and furthermore to the injection molding machine 4 and can be immediately included into the calculation.

As a matter of principle, the load level 28 can be selected in such a way that the duration of the exceedance of this load level 28 and thus of the presence of the control signal 22 for load peaks 21 does not exceed the time of approximately 15% to 25% of a total cycle of the injection molding machine 4. If the control signal 22 is present for a longer period of time, it must be assumed that the production resources 2 may have to ignore the control signal 22 and independently switch on the internal load consumers in order not to endanger the process control. Upon correct selection of the level or load level 28, respectively, the production resource 2 switch off the internal load consumers, delay switching on or reduce the load, depending on the technical possibility.

Here it is also possible that the production resources 2 are also designed to be self-learning and can anticipate the occurrence of a load peak 21 on the injection-molding machine 4, since the temporal behavior in automatic operation of the injection-molding machine 4 is relatively deterministic. With predictive control in the production resource 2, load generators, e.g. heating elements, can switch on the load shortly before the probable occurrence of a load peak 21 at the injection-molding machine 4 and then switch it off again. Due to the energetic inertia of heating elements, or respectively of thermocouples in general, preheating can be achieved before the normal control process is started after the load on the injection-molding machine 4 drops, so that the setpoint state of the control parameter can be reached more quickly.

Thus, it is possible e.g. that upon transmission of a signal 22 from the injection-molding machine 4 or the work cell controller 26 to a temperature control unit 13a, the latter is informed that the next production phase 19 is above the preset load level 28, so that any pending controls in the temperature control unit 13a should be brought forward or postponed or split up if the corresponding parameter settings in the temperature control unit 13a permit this. Thus, after receiving the signal 22, the temperature control unit 13a can, for example, preheat its heating elements and switch off or reduce them during the production phase 19 in which the load level 28 is exceeded, in order to subsequently complete the control or regulation process, respectively. This ensures that in those areas in which the load level 28 is exceeded, the further production resources 2 try to take up preferably no or necessarily only a small amount of energy, respectively, in order to prevent further accumulation of energy consumption.

The load management system may further report to the production resource 2 the magnitude of the load peak 21 or the difference between the load peak 21 and the base load, or any other measurand that is directly or indirectly indicative of the subsequent load requirement. The load peak 21 may have been determined either by calculation or by a previous power measurement. The difference between load peak 21 and base load (load reserve) is also calculated or determined by measurement. Typically, the load reserve is much larger than the load consumption of a single production resource 2 is, i.e., during the phases in which the injection-molding machine 4 does not cause load peaks 21, several production resources 2 can run simultaneously and still not reach the maximum load peak level 21 of the injection-molding machine 4. Thus, it is advantageous if the work processes of the other production resources 2 are moved to those production areas 19 in which no load peaks 21 are to be expected from the injection-molding machine.

In a further embodiment, the production resources 2 can be addressed sequentially for load consumption after the load drop of the injection molding machine 4, i.e., for example, after the load peak 21 has been undershot, a corresponding further signal 29 with corresponding information is transmitted. The sequence is determined statically or dynamically by a given priority of the individual production resources 2. This can be determined by the degree of process relevance of the production resources 2 or the amount of load consumption. The load reserve is passed on to the production resource 2 in the order of priority, whereby in the event of load requirement, these means 2 deduct this own load requirement from the load reserve and pass it on to the subsequent production resource 2. In this case, the transfer of the load reserve must be ordered cyclically by the injection molding machine 4.

The method is based on the ability of the individual production resources 2 to have load-influencing components and to influence the internal process by means of corresponding control signals 22, 29. The higher the number of such load-influenceable components of a production resource 2, the greater the probability of obtaining a response of the production resources 2 requested by the injection molding machine 4 and the load management.

Furthermore, FIG. 5 shows averaged energy consumption, whereas FIG. 6 shows a non-averaged energy consumption.

Consideration of the energy consumption of production resources 2, in particular of a primary production resource 2, e.g. an injection-molding machine 4, is usually based on average values. Typically, an evaluation period 30 of 15 minutes is used, since utility companies in numerous countries also use the average consumption in the respective 15-minute period for the billing of electricity consumption. From this point of view, the start-up 31 of the injection-molding machine 4 requires the most energy. After production has started 32 and a constant production cycle 33 been reached, the average consumption assumes a lower averaged load level. FIG. 5 presents the average consumptions with an evaluation period 30 of 5 seconds. In the case of a longer average calculation, for example when using the usual evaluation period 30 of 15 minutes, the values are displayed in a correspondingly smoother way. Specifically, the stable production phase 19 will indicate a lower value than shown in FIG. 6. The load peak management of commercially available systems therefore also focuses on avoidance, in particular by load shifting, load reduction, load shedding, load sharing, of simultaneously occurring phases with a high average energy level.

FIG. 6, on the other hand, illustrates the energy consumption of a primary production resource 2, e.g. an injection-molding machine 4, without filtering, whereby a very different picture emerges. Especially during the usual production cycles 33, the load peaks 21 become more prominent. It can be seen that the highest load peaks 21 do not occur during the start-up phase 32 of the injection-molding machine 4, but only during the regular operation or production cycle 33, respectively, of the machine. This is significant in that the highest load peak 21 in the company's electricity demand determines the amount of the grid usage fee charged by the grid operator or the electricity supplier. In many cases, the cost of the grid usage fee exceeds the cost of current electricity consumption. Overlapping of load peaks 21 of primary production resource, e.g. an injection-molding machine 4, and the production resource 2 involved in the production is therefore advantageous.

For the sake of completeness, it is mentioned that in this approach the further necessary connections between the injection molding machine 4, the molding tool 7, the production resource 2 or further components important for the production are not mentioned and shown. These are typically electrical and/or water and/or hydraulic and/or air connections and are essential for the correct functionality of the entire production cell.

It can thus be stated that, according to the present invention, a method for avoiding parallel occurrence of load peaks 21 of a plastics processing machine, in particular an injection-molding machine 4 or forming machine and at least one production resource 2, such as temperature control units 13a, hot runner systems, cooling units 13b, flow controllers 14, granule dryers 12, mold dryers, metering devices 11, robots 5, automation systems, etc., has been disclosed, wherein the injection-molding machine 4 is connected via an electrical line 27 or data line 27 to the at least one production resource 2 directly or indirectly via an external work cell controller 26, wherein the injection-molding machine 4 or molding machine sends an advance control signal 22 or an internal operating state 22 with increased load requirement to the production resource 2, so that the at least one production resource 2 performs a load shift, load reduction or load shedding at the times 24 of the increased load requirement of the injection-molding machine 4. Advantageously, this prevents overlapping of load peaks 21 of an injection molding machine 4 and the production resources 2 involved in production.

It is pointed out that the invention is not limited to the embodiments shown, but may comprise further embodiments and designs.

1. A method for avoiding parallel occurrence of load peaks of a plastics processing machine, in particular an injection molding machine and at least one production resource, for example a temperature control unit, hot runner system, cooling unit, flow controller, granule dryer, mold dryer, metering device, robot, automation system, etc., wherein the injection-molding machine is connected via an electrical line or data line to the at least one production resource directly or indirectly via an external work cell controller, characterized in that wherein the injection-molding machine or the external work cell controller transmits one or several control signals or internal operating states with increased load requirement, to the production resource so that the production resource performs a load shift, load reduction or load shedding at the times of the increased load requirement of the injection-molding machine.

2. The method according to claim 1, wherein the load level for the activation of the control signal or control signals or the change of the internal operating state or operating states for the transmission or indication, respectively, of the presence of a load peak in the injection-molding machine or a work cell controller is freely selectable, adjustable or automatically determined.

3. The method according to claim 1, wherein the injection-molding machine continuously determines by calculation or ascertains by measurement the load level present during one or several operating cycles, in particular the operation between two successive closing operations of the mold, and stores it for subsequent analyses, in particular for determining the switching of the control signal or control signals or the internal operating states.

4. The method according to claim 1, wherein an external work cell controller continuously ascertains by measurement the load level present during one or several operating cycles of the injection-molding machine, in particular the operation between two successive closing operations of the mold, and stores it for subsequent analyses, in particular for determining the switching of the control signal or control signals or the internal operating states.

5. The method according to claim 1, wherein the injection-molding machine or an external work cell controller can also send or indicate, respectively, the control signal or control signals or internal operating states with increased load requirement in advance, so that the production resource can prepare corresponding actions for load control.

6. The method according to claim 1, wherein the production resources are also designed to be self-learning and, preferably after tracking the behavior of the control signal or control signals or the internal operating states at least once in an operating cycle of the injection-molding machine, can anticipate the occurrence of a load peak in the injection-molding machine and automatically carry out a load control.

7. The method according to claim 1, wherein, in the case of automatic determination of the switching points of the control signal or control signals or of the internal operating states as a function of the load level by the injection-molding machine or an external work cell controller, the cumulative presence of the control signal or signals or of the internal operating states for load peaks does not exceed the time of approximately 15% to 25% of a total cycle of the injection-molding machine.

8. The method according to claim 1, wherein the injection-molding machine reports the difference between the maximum load peak in an operating cycle and the currently calculated or measured load or another measurand which directly or indirectly indicates the currently unneeded load requirement to a work cell controller.

9. The method according to claim 1, wherein an external work cell controller determines the difference between the maximum load peak in an operating cycle of the injection-molding machine and the currently measured load of the injection-molding machine and uses this to form the currently unneeded load requirement of the injection-molding machine.

10. The method according to claim 1, wherein an external work cell controller transmits the control signal or control signals to the production resource at different times, depending on the load consumption of the respectively active production resource, so that the total load of the production resource does not exceed the load requirement not needed by the injection-molding machine.

11. A plastics processing plant comprising at least an injection-molding machine and at least one production resource, such as a temperature control unit, hot runner system, cooling unit, flow controller, granule dryer, mold dryer, metering device, robot, automation systems, etc., wherein the injection-molding machine is connected via an electrical line or data line to the at least one production resource directly or indirectly via an external work cell controller, wherein the injection-molding machine is designed for carrying out the method according to claim 1.
